(19) United States
(12) Patent Application Publication
(10) Pub. No.: US 2007/0009697 A1
(43) Pub. Date: Jan. 11, 2007

(54) Straight line speed masking tape

(76) Inventors: Scott S. Silva, Pismo Beach, CA (US); Wilbur W. Silva, Modesto, CA (US)

Correspondence Address: WILBUR W. SILVA, 1705 DUCKART WAY, MODESTO, CA, 95355, US

(21) Appl. No.: 11/177,453

(22) Filed: Jul. 11, 2005

(51) Int. Cl. B32B 33/00

(52) U.S. Cl. 428/40.1; 428/43

(57) ABSTRACT

A roll of pressure sensative masking tape constructed and configured to provide straight line masking of a surface, or trim, that is both fast and accurate, containing straight line lateral tearage points located at strategig points longitudinally.

### BACKGROUND OF THE INVENTION

1. Technical Field

Generally the use of masking tape utilized in preparation of painting various surfaces in a house is very time consuming for the worker to administer the tape on a surface to be accurate, such as masking off a window to paint the frame or surrounding surfaces. The object of the Straight Line Speed Masking Tape of this invention is to accurately apply it in a fashion to save up to 75% of the time required by conventional masking tape and because of the accuracy, drastically reduce both clean up and detail time.

2. Description of Prior Art

U.S. Pat. No. 6,773,406 describes a heat resistant, pressure sensative adhesive composition, primarily utilized in automobile painting.

U.S. Pat. No. 5,049,445 depicts a form of masking tape and method of manufacture of such tape, where in said tape utilizes a wider strip of tearable material with a coated adhesive lower face, with a second longitudinal narrow adhesive strip to enable taping on a necessary curved section.

U.S. Pat. No. 4,389,270 illustrated a composite pressure sensative configuration containing a central release liner with a layer of adhesive on each side and an exterior release liner on at least one of the adhesive layers. This application is utilized in the sealing of insulated jackets around a pipe.

References Cited (Referenced By)
U.S. Patent Documents

| | | | |
|---|---|---|---|
| 4,704,315 | November 1987 | Mc Clintock | 42828/343 |
| 4,770,914 | September 1988 | Torgerson et al | 428/343 |

### SUMMARY OF THE INVENTION

The object of the invention is to provide rolls of a pressure sensative type of masking tape to enable a worker to prepare surfaces for painting in a home in a fraction of time required by use of conventional tape, therefore increasing efficiency and significantly reducing preparation time and cost.

### DESCRIPTION OF THE DRAWINGS

FIG. 1 depicts an enlarged side view of a portion of pressure sensative masking tape, 11, with a layer of adhesive, 12, applied to the under side of said tape, 11.

FIG. 2 shows an enlarged side view of a thin strip of plastic type stiffener material, 13 and the lateral tearage perforations, 14.

FIG. 3 sets forth an enlarged side view of the arrangement of the components, 11, masking tape, 12, adhesive applied to the bottom surface of the masking tape, 11 and the strip of plastic type stiffener, 13, to be bonded to the upper surface of the masking tape, 11 and the lateral tearage perforations, 14.

FIG. 4 is a top view of a portion of a two inch masking tape, 11, that includes the adhesive, 12, applied to the bottom surface of masking tape, 11 and the strip of plastic type stiffener, 13, bonded to the top surface of the masking tape, 11.

FIG. 5 depicts a top; view of a portion of the finished product of Straight Line Speed Masking Tape with the adhesive, 12, applied to the bottom side of the masking tape, 11, the thin plastic stiffener type material, 13, bonded to the top surface of the masking tape, 11, and the interval placement of straight line one inch lateral tearage perforations, 14, across the 2 inch wide Straight Line Speed Making Tape.

### DESCRIPTION OF THE PREFERRED EMBODIMENT

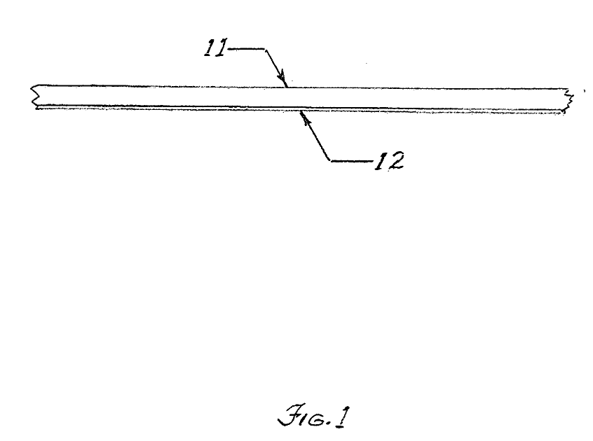

FIG. 1 shows a side view of masking tape material, 11, with the adhesive, 12, applied to the underside of the masking tape.

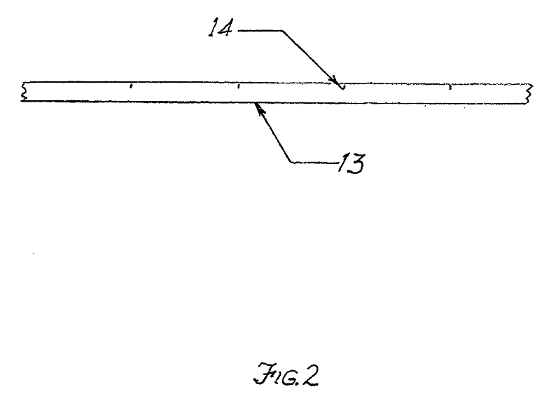

FIG. 2 depicts an enlarged side view of the plastic type stiffener material, 13 with the tearage perforations, for lateral straight line tearage, 14.

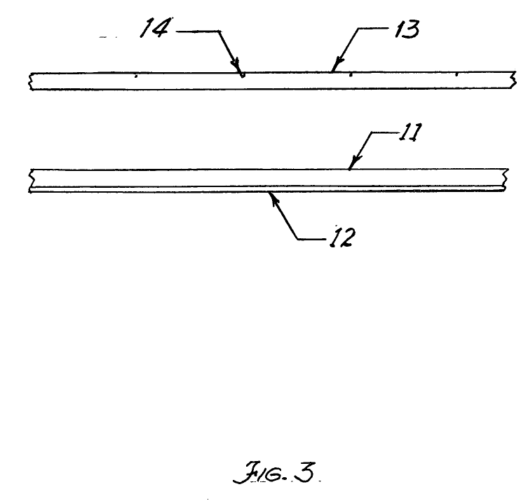

FIG. 3 reveals an enlarged side view of the pressure sensative tape, 11, with the adhesive, 12, applied to the underside with the plastic type stiffener material ready to be bonded to the top surface of the tape, Hand the spacing of the lateral tearage perforations, 14.

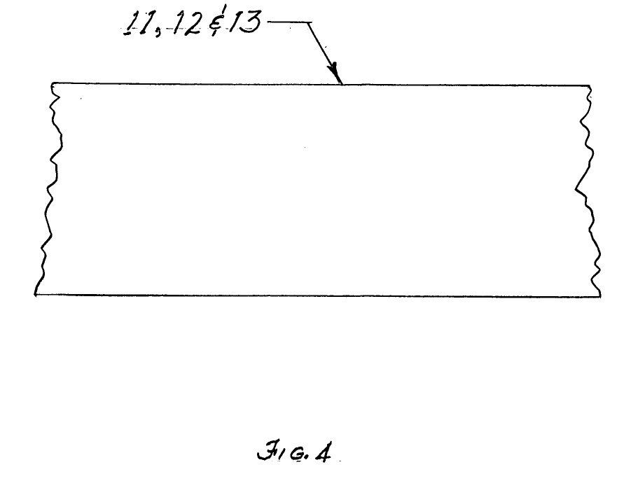

FIG. 4 shows a top view of the three components of the masking tape bonded together.

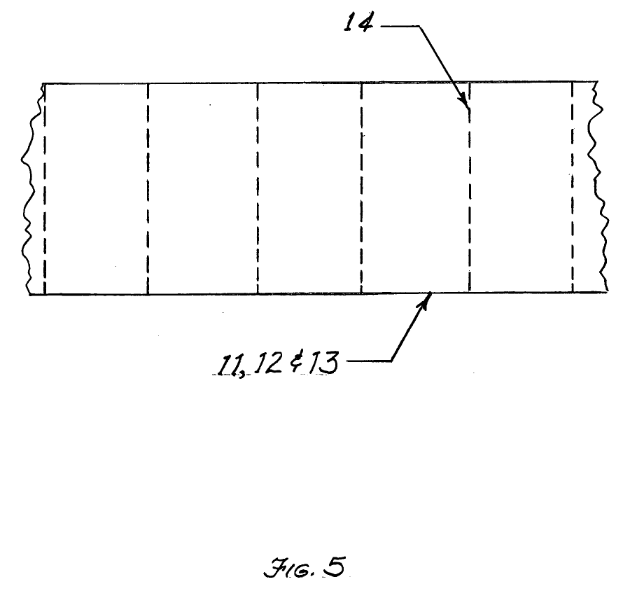

FIG. 5 depicts a top view of the finished product with the placement of the lateral tearage perforations, 14, always being ½ the width of the tape for straight line tearage. In order to cover the uncovered portion, of a surface at the point of tearage, simply begin a new run of the tape perpendicular to the previous tearage point. The perforations, 14, do not compromise the strength of the tape, as the depth of the perforations are only present in the stiffener material, 13. The reason for the stiffener, 13, to be bonded to the upper surface of the pressure sensative masking tape, 11, is to provide more firm edges of the tape to prevent the tape from riding up on a perpendicular surface that one wishes to paint. The flexibility of the tape is not compromised, allowing for a firm straight edge for accuracy and speed of application.

1. A roll of pressure sensative Straight Line Speed Masking Tape comprising a standard adhesive applied to the under side with a thin plastic type stiffener material bonded to the upper surface.

2. The plastic type stiffener bonded to the upper surface as in claim 1, provides lateral stiffness, resulting in straight line edges when applied to a surface.

3. The lateral perforations of the plastic type material stiffeners of claim 1, provide straight line lateral tearage of said tape.

4. The strategic placement of the lateral perforations of claim 3 for straight line lateral tearage results in complete coverage of any 90 degree application of said tape.
